(19) United States
(12) Patent Application Publication
(10) Pub. No.: US 2026/0264628 A1
(43) Pub. Date: Sep. 10, 2026

(54) EXTERIOR A-PILLAR GARNISH TUNABLE GASKET

(71) Applicant: Honda Motor Co., Ltd., Tokyo (JP)

(72) Inventors: Timothy J. RUPP, Dublin, OH (US); Juan Antonio VELA GONZALEZ, Monterrey (MX); Douglas R. KALTENMARK, Powell, OH (US)

(21) Appl. No.: 19/073,401

(22) Filed: Mar. 7, 2025

(51) Int. Cl. B60R 13/04; B29L 31/30

(52) U.S. Cl. CPC B60R 13/04; B29L 2031/3041

(57) ABSTRACT

A vehicle garnish includes a body having an outer surface forming part of a vehicle exterior surface, an inner surface opposite the outer surface in a thickness direction of the body, and a peripheral edge portion. A one-piece seal is nonremovably secured to inner surface of the body and is extended at least partially along the peripheral edge portion. The seal is configured to have two or more different cross-sectional profiles at different sealing surfaces of the seal along the peripheral edge portion.

### BACKGROUND

A garnish is generally interposed between a windshield and a side window and is configured for preventing rain from sliding across the exterior surface of the vehicle, from the windshield to the side window according to a headwind of the vehicle when the vehicle is being driven. Most garnishes have different sections depending on the interface, and seals for the garnishes are typically extruded continuous cross-section shapes bonded to an underside of the garnish using tape or adhesive. Depending on the bonding performance of the tape, a thickness of the tape can vary from 0.4mm to 1mm, reducing the packaging space. In addition, because the seals at the different interfaces may have different cross-sectional profiles, the seals are separate parts of the molding and, therefore, can increase the risk of part variation. Using multiple extruded seals for the garnish can often leave gaps where seals meet up in the corners of the molding. Also, to modify a specific struggle area along one of the interfaces for sealing, the entire length of the seal may need to be modified.

### BRIEF DESCRIPTION

According to one aspect, a vehicle garnish comprises a body having an outer surface forming part of a vehicle exterior surface, an inner surface opposite the outer surface in a thickness direction of the body, and a peripheral edge portion. A one-piece seal is nonremovably secured to inner surface of the body and is extended at least partially along the peripheral edge portion. The seal is configured to have two or more different cross-sectional profiles at different sealing surfaces of the seal along the peripheral edge portion.

According to another aspect, a vehicle comprises a body including an A-pillar, a windshield having an exterior surface and a lateral edge secured to the body, and a garnish secured to the body and covering the A-pillar. The garnish includes a garnish body having an outer surface forming part of a vehicle exterior surface, an inner surface opposite the outer surface in a thickness direction of the garnish body, and a peripheral edge portion. A one-piece seal is nonremovably secured to inner surface and is extended at least partially along the peripheral edge portion. The seal is configured to have a first cross-sectional profile at a first sealing surface of the seal for sealingly engaging the exterior surface of the windshield, and a second cross-sectional profile at a second sealing surface of the seal for sealingly engaging the body.

According to another aspect, a method of producing a vehicle garnish comprises injection molding a one-piece seal configured to have two or more different cross-sectional profiles at different sealing surfaces of the seal; providing a garnish having a body with an outer surface, an inner surface opposite the outer surface in a thickness direction of the body, and a peripheral edge portion; and nonremovably securing the seal to the inner surface of the body such that the seal is extended at least partially along the peripheral edge portion.

### BRIEF DESCRIPTION OF THE DRAWINGS

FIG. 1 is a partial schematic view of a vehicle including a garnish covering an A-pillar of a vehicle body.

FIG. 2 is a bottom view of a known garnish.

FIG. 3 is a cross-sectional view taken along line 3-3 of FIG. 2.

FIG. 4 is a cross-sectional view taken along line 4-4 of FIG. 2.

FIG. 5 is a cross-sectional view taken along line 5-5 of FIG. 2.

FIG. 6 is a cross-sectional view taken along line 6-6 of FIG. 2.

FIG. 7 is a cross-sectional view taken along line 7-7 of FIG. 2.

FIG. 8 is a bottom view of a garnish according to the present disclosure.

FIG. 9 is a cross-sectional view taken along line 9-9 of FIG. 8.

FIG. 10 is a cross-sectional view taken along line 10-10 of FIG. 8.

FIG. 11 is a cross-sectional view taken along line 11-11 of FIG. 8.

FIG. 12 is a cross-sectional view taken along line 12-12 of FIG. 8.

FIG. 13 is a cross-sectional view taken along line 13-13 of FIG. 8.

FIG. 14 is a cross-sectional view taken along line 14-14 of FIG. 8.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Further, any term of degree used herein, such as "substantially", means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

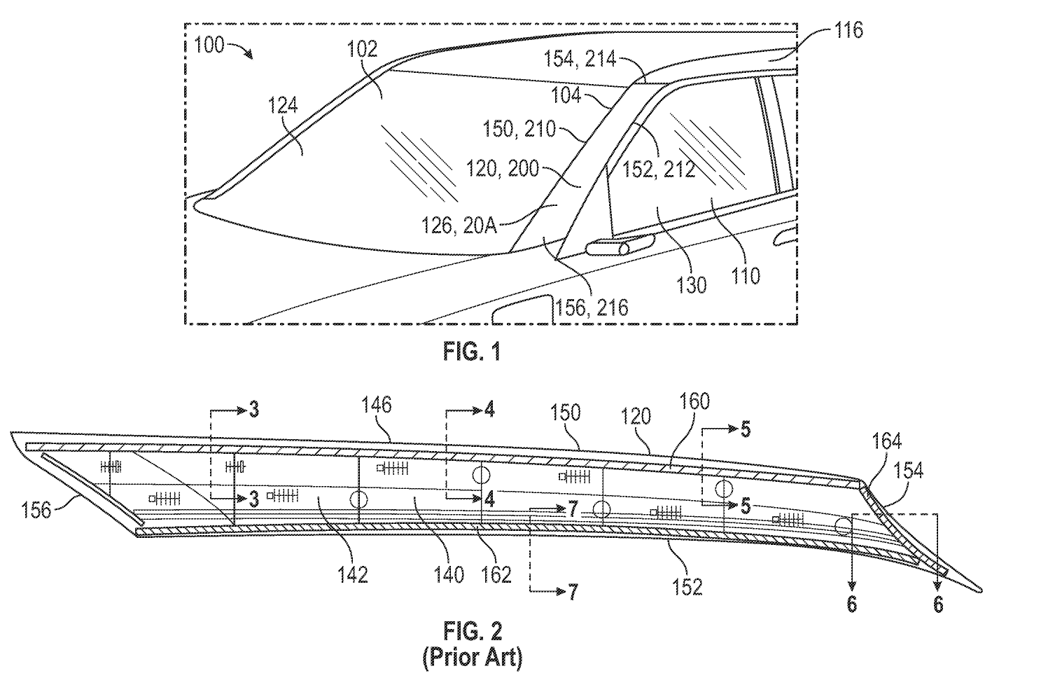

Referring now to the drawings, wherein like numerals refer to like parts throughout the several views, FIG. 1 depicts a vehicle 100 including a front windshield 102, an A-pillar 104, a driver’s side window 110, and a right roof rail 116. As is known in the art, the A-pillar 104 and the roof rail 116 define part of a vehicle frame or body 118 (FIG. 3). A garnish 120 covers the A-pillar 104. The A-pillar 104 is interposed between and separates the windshield 102 from the side window 110 in a lateral (i.e., width) direction of the vehicle 100, specifically in a left-right direction of the vehicle 100, such that an exterior surface of the vehicle 100 includes an exterior surface 124 of the windshield 102, an exterior surface of the A-pillar 104 (defined, for example, by an outer surface 126 of the garnish 120), and an exterior surface 130 of the side window 110 along the lateral direction of the vehicle 100.

FIG. 2 depicts a known construction of the garnish 120. The garnish 120 includes a body 140 having the outer surface 126 forming part of the vehicle exterior surface, an inner surface 142 opposite the outer surface 126 in a thickness direction of the garnish body 140, and a peripheral edge portion 146. The peripheral edge portion 146 includes a first side edge portion 150, a second side edge portion 152 opposite the first side edge portion 150 along a first (i.e., width) direction of the garnish body 140, a first end edge portion 154, and a second end edge portion 156 opposite the first end edge portion along a second (i.e., length) direction of the garnish body 140 transverse to the first direction. The first side edge portion 150 is located closer to the windshield 102 as compared to the side window 110, and the second side edge portion 152 is located closer to the side window 110 as compared to the windshield 102. The first end edge portion 154 is located closer to the roof rail 116 as compared to the second end edge portion 156.

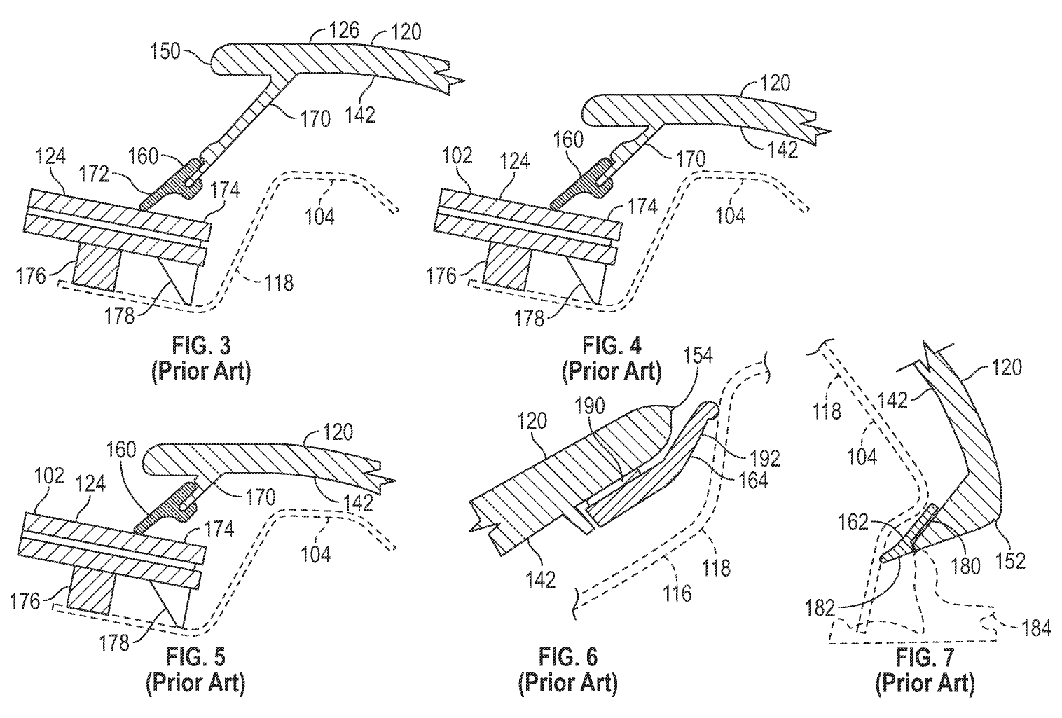

The garnish 120 in FIG. 2 includes a first seal 160 extended along the first side edge portion 150, a second seal 162 extended along the second side edge portion 152, and a third seal 164 extended along the first end edge portion 154. A fourth seal (not shown) can extend along the second end edge portion 156. Each of the first seal 160, the second seal 162, and the third seal 164 is a separate and distinct extruded part of the garnish 120 with a different cross-sectional profile. In FIG. 3, the first seal 160 is connected to a mounting portion 170 on the inner surface 142 of the garnish 120 and has a first sealing section 172 for sealingly engaging a lateral side edge 174 of the windshield 102. Further depicted in FIG. 3 is the lateral side edge 174 adhered to the vehicle body 118 via a tape or adhesive 176 provided laterally inside of a windshield seal 178. Because the first seal 160 is an extruded part having a constant configuration (i.e., cross-sectional profile) along a length of the first seal 160, due to the sloping shape of the A-pillar 104 the mounting portion 170 has to change in size to ensure the sealing of the lateral side edge 174 of the windshield 102. In FIG. 3, the mounting portion 170 is extended the farthest for the inner surface 142 of the garnish 120, in FIG. 4 the mounting portion 170 is not extended as far as FIG. 3, and in FIG. 5 the mounting portion 170 is closest to the inner surface 142. Therefore, the garnish body 140 has to be adapted or tuned to the windshield 102 and the vehicle body 118, and is done so with the mounting portion 170 having differing sizes along the length of the garnish 120.

In FIG. 7, the second seal 162 is adhered to the inner surface 142 of the garnish 120 via a tape or adhesive 180 and has a second sealing section 182 for sealingly engaging the vehicle body 118 near a weatherstrip 184 for the side window 110. In FIG. 6, the third seal 164 is adhered to the inner surface 142 of the garnish 120 via a tape or adhesive 190 and has a third sealing section 192 for sealingly engaging the vehicle body 118. As indicated, a thickness of each tape 180, 190 can vary from 0.4mm to 1mm, reducing the packaging space of the garnish 120 relative to the vehicle body 118. In addition, because the seals 160, 162, 164 are separate extruded parts with different cross-sectional profiles, there is an increased risk of variation between the garnishes for a specific vehicle model. Further, with the separate seals 160, 162, 164, gaps can form where the first and third seals 160, 164 meet up in one corner of the garnish 120 and where the second and third seals 162, 164 meet up in another corner of the garnish 120.

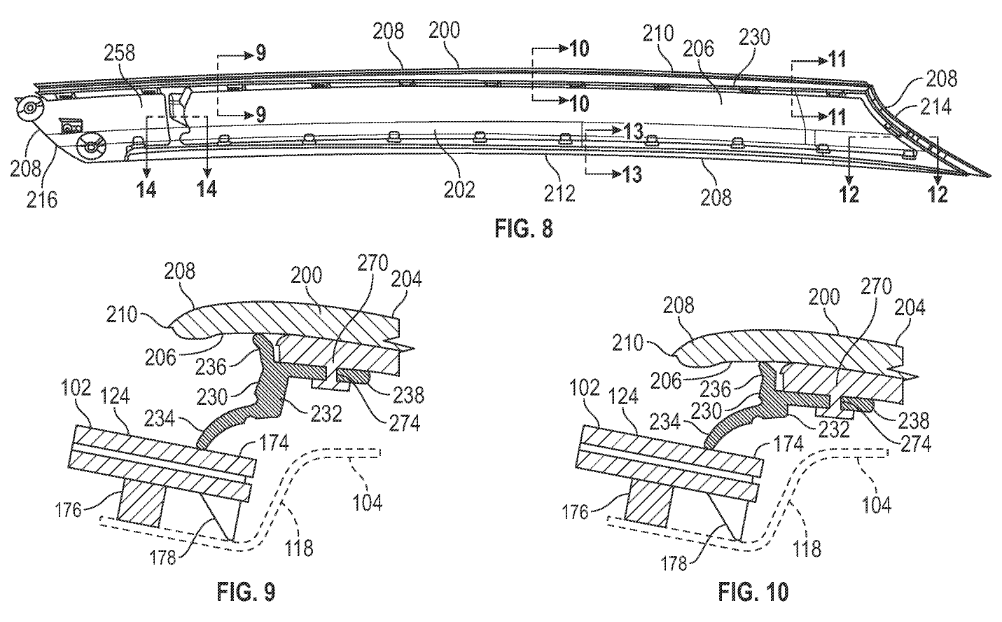

FIGS. 1 and 8 depict a construction of a garnish 200 according to the present disclosure. The garnish 200 includes a body 202 having an outer surface 204 forming part of the vehicle exterior surface, an inner surface 206 opposite the outer surface 204 in a thickness direction of the garnish body 202, and a peripheral edge portion 208. The peripheral edge portion 208 includes a first side edge portion 210, a second side edge portion 212 opposite the first side edge portion 210 along a first (i.e., width) direction of the garnish body 202, a first end edge portion 214, and a second end edge portion 216 opposite the first end edge portion along a second (i.e., length) direction of the garnish body 202 transverse to the first direction. The first side edge portion 210 is located closer to the windshield 102 as compared to the side window 110, and the second side edge portion 212 is located closer to the side window 110 as compared to the windshield 102. The first end edge portion 214 is located closer to the roof rail 116 as compared to the second end edge portion 216.

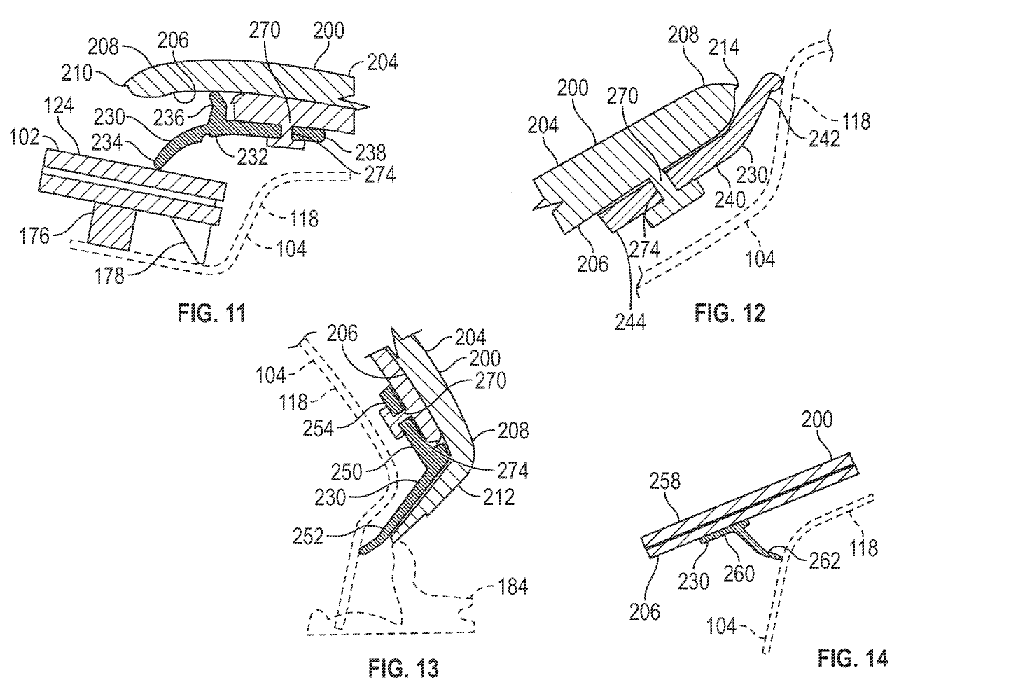

A one-piece seal 230 is nonremovably secured to the inner surface 206 of the garnish body 202 and is extended at least partially along the peripheral edge portion 208. The seal 230 at least partially defines a water gutter along the peripheral edge portion 208 of the garnish. The seal 230 is configured to have two or more different cross-sectional profiles at different sealing surfaces of the seal along the peripheral edge portion 208, thereby allowing the seal to be adapted or tuned to the specific shape of the A-pillar instead of the garnish 200. In FIGS. 9-11, a first sealing surface of the seal 230 extends along the first side edge portion 210 and has a first cross-sectional profile that can vary in configuration (for example, scale or size) along the length of the seal 230. The seal 230 along the first side edge portion 210 generally includes a body section 232, a first sealing lip 234 extended from the body section for sealingly engaging the lateral side edge 174 of the windshield 102, a second sealing lip 236 extended from the body section for sealingly engaging the lateral side edge 174 of the windshield 102 the inner surface 206 of the garnish body 202, and a mounting section 238. In FIG. 9, the first cross-sectional profile of the seal 230 is enlarged as compared to the first cross-sectional profiles of the seal 230 in FIGS. 10 and 11, which depict the first cross-sectional profile becoming progressively smaller as the seal 230 is extended along the first side edge portion 210 toward the roof rail 116. Of note in FIGS. 9-11, the shape of the garnish body 202 along the first side edge portion 210 is substantially constant. Therefore, the first cross-sectional profile of the seal 230 along the first side edge portion 210 is tuned to the windshield 102 and the vehicle body 118 instead of the garnish 200.

In FIG. 12, a second sealing surface of the seal 230 extends along the first end edge portion 214 and has a second cross-sectional profile different from the first cross-sectional profile along the first side edge portion 210. The seal 230 along the first end edge portion 214 includes a body section 240, a seal lip 242 extended from the body section for sealingly engaging the vehicle body 118 and a mounting section 244. In FIG. 13, a third sealing surface of the seal 230 extends along the second side edge portion 212 and has a third cross-sectional profile different from each of the first and second cross-sectional profiles. The seal 230 along the second side edge portion 212 includes a body section 250, a seal lip 252 extended from the body section for sealingly engaging the vehicle body 118 near the weatherstrip 184 for the side window 110 and a mounting section 254. In FIG. 14, a fourth sealing surface of the seal 230 extends along a bottom portion 258 of the garnish 200 near the second end edge portion 216 and is provided to prevent air, water and debris from flowing under the garnish body 202. The fourth sealing surface of the seal 230 has a fourth cross-sectional profile different from the other cross-sectional profiles. The seal 230 along the bottom portion 258 includes a body section 260 and a seal lip 262 extended from the body section for sealingly engaging the vehicle body 118.

As indicated, the one-piece seal 230 is nonremovably secured to the inner surface 206 of the garnish body 202. According to one aspect, the seal 230 is heat staked to the inner surface 206. As shown in FIGS. 9-13, a plurality of stakes 270 integral with the inner surface 206 of the garnish body 202 are provided at least along the peripheral edge portion 208. The seal 230 includes a plurality of through holes 274 in the mounting sections 238, 244, 254 for receiving the plurality of stakes. The stakes 270 are heated to just above the glass transition temperature of the material of the stakes 270 while simultaneously applying force so that the stakes are deformed. The stakes 270 are then cooled (still under force) to complete the heat staking process. In FIG. 14, the body section 260 of the seal 230 can be adhered to the inner surface 206. According to another aspect, the seal 230 is overmolded onto the inner surface 206 of the garnish body 202 using known techniques.

Therefore, instead of using multiple seal extrusions around the garnish as shown in FIGS. 2-7, the seal 230 is injection molded into one piece and attached to the garnish body 202 using heat-stake or overmold techniques. This allows for a more robust design of the seal 230 by removing any gapping or rat holes between seal sections as per the known design and removing part assembly variation. Also, using an injection molded part allows for molding and adapting any shape of the seal 230 necessary to ensure continuous sealing around the peripheral edge portion 208 of the garnish 200, achieving better wind noise and water management. The present disclosure also allows better tunability of the seal 230 allowing the design to adapt to performance requirements as needed. With the present disclosure, part quality, fit and finish of the garnish 200 to the vehicle body 218 is improved.

The present disclosure further teaches a method of producing the vehicle garnish 200. The exemplary method comprises injection molding the one-piece seal 200 configured to have two or more different cross-sectional profiles at different sealing surfaces of the seal; providing the garnish 200 having the garnish body 202 with the outer surface 204, the inner surface 206 opposite the outer surface in a thickness direction of the body, and the peripheral edge portion 208; and nonremovably securing the seal 230 to the inner surface 206 of the garnish body 202 such that the seal is extended at least partially along the peripheral edge portion 208. According to one aspect, the method includes heat staking the seal 230 to the inner surface 206 of the garnish body 202. According to another aspect, the method includes overmolding the seal 230 onto the inner surface 206 of the body 202.

The exemplary method includes providing a first sealing surface having a first cross-sectional profile along the first side edge portion 210 of the peripheral edge portion 208, and providing a second sealing surface having a second cross-sectional profile different from the first cross-sectional profile along the first end edge portion 214 of the peripheral edge portion 208. According to one aspect, the method includes varying a dimension or scale of the first cross-sectional profile along a length of the seal 230.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A vehicle garnish comprising:
a body having an outer surface forming part of a vehicle exterior surface, an inner surface opposite the outer surface in a thickness direction of the body, and a peripheral edge portion; and
a one-piece seal nonremovably secured to inner surface of the body and extended at least partially along the peripheral edge portion, wherein the seal is configured to have two or more different cross-sectional profiles at different sealing surfaces of the seal along the peripheral edge portion.

2. The vehicle garnish of claim 1, wherein the seal is heat staked to the inner surface.

3. The vehicle garnish of claim 1, wherein the seal is overmolded onto the inner surface of the body.

4. The vehicle garnish of claim 1, wherein the peripheral edge portion includes a first side edge portion, a second side edge portion opposite the first side edge portion along a first direction of the body, a first end edge portion, and a second end edge portion opposite the first end edge portion along a second direction of the body transverse to the first direction, and the seal extends along the first side edge portion and the first end edge portion.

5. The vehicle garnish of claim 4, wherein a first sealing surface of the seal extends along the first side edge portion and has a first cross-sectional profile, and a second sealing surface of the seal extends along the first end edge portion and has a second cross-sectional profile different from the first cross-sectional profile.

6. The vehicle garnish of claim 5, wherein the first cross-sectional profile varies in scale along a length of the seal.

7. The vehicle garnish of claim 5, wherein the seal extends along the second side edge portion.

8. The vehicle garnish of claim 7, wherein a third sealing surface of the seal extends along the second side edge portion and has a third cross-sectional profile different from each of the first cross-sectional profile and the second cross-sectional profile.

9. The vehicle garnish of claim 8, wherein a fourth sealing surface of the seal extends along the second end edge portion and has a fourth cross-sectional profile different from each of the first cross-sectional profile, the second cross-sectional profile, and the third cross-sectional profile.

10. The vehicle garnish of claim 1, wherein the garnish is an A-pillar garnish.

11. A vehicle comprising:
a body including an A-pillar;
a windshield having an exterior surface and a lateral edge secured to the body;
a garnish secured to the body and covering the A-pillar, wherein the garnish includes a garnish body having an outer surface forming part of a vehicle exterior surface, an inner surface opposite the outer surface in a thickness direction of the garnish body, and a peripheral edge portion; and
a one-piece seal nonremovably secured to inner surface and extended at least partially along the peripheral edge portion, wherein the seal is configured to have a first cross-sectional profile at a first sealing surface of the seal for sealingly engaging the exterior surface of the windshield, and a second cross-sectional profile at a second sealing surface of the seal for sealingly engaging the body.

12. The vehicle of claim 11, wherein the seal is heat staked to the inner surface.

13. The vehicle of claim 11, wherein the seal is overmolded onto the inner surface of the garnish body.

14. The vehicle of claim 11, wherein the seal is configured to have a third cross-sectional profile at a third sealing surface for sealingly engaging the body, the third cross-sectional profile different from each of the first cross-sectional profile and the second cross-sectional profile.

15. The vehicle of claim 11, wherein the first cross-sectional profile varies in scale along a length of the seal.

16. A method of producing a vehicle garnish, comprising:
injection molding a one-piece seal configured to have two or more different cross-sectional profiles at different sealing surfaces of the seal;
providing a garnish having a body with an outer surface, an inner surface opposite the outer surface in a thickness direction of the body, and a peripheral edge portion; and
nonremovably securing the seal to the inner surface of the body such that the seal is extended at least partially along the peripheral edge portion.

17. The method of claim 16, including heat staking the seal to the inner surface.

18. The method of claim 16, including overmolding the seal onto the inner surface of the body.

19. The method of claim 16, including providing a first sealing surface having a first cross-sectional profile along a first side edge portion of the peripheral edge portion, and providing a second sealing surface having a second cross-sectional profile different from the first cross-sectional profile along a first end edge portion of the peripheral edge portion.

20. The method of claim 19, including varying a scale of the first cross-sectional profile along a length of the seal.
